(19) United States
(12) Patent Application Publication
(10) Pub. No.: US 2025/0390070 A1
(43) Pub. Date: Dec. 25, 2025

(54) METHOD FOR SENSOR DATA PROCESSING, METHOD FOR ENVIRONMENT OBJECT DETECTION, METHOD FOR CONTROL, AND PROCESSING DEVICE

(71) Applicant: Robert Bosch GmbH, Stuttgart (DE)

(72) Inventors: Kilian Rambach, Stuttgart (DE); Daniel Kenta Jenet, Stuttgart (DE); Maurice Quach, Ditzingen (DE); Maxim Tatarchenko, Berlin (DE); Oliver Kern, Renningen (DE); Sascha Braun, Reutlingen (DE); Yuri Feldman, Haifa (IL)

(21) Appl. No.: 19/245,519

(22) Filed: Jun. 23, 2025

(30) Foreign Application Priority Data
Jun. 25, 2024 (DE) 10 2024 205 895.5

(51) Int. Cl. G05B 13/04

(52) U.S. Cl. CPC G05B 13/041

(57) ABSTRACT

A method for sensor data processing of sensor data of at least one environmental sensor, a method for environment object detection, a method for control of at least one operating parameter, and a processing device are described.

### CROSS REFERENCE

The present application claims the benefit under 35 U.S.C. § 119 of German Patent Application No. DE 10 2024 205 895.5 filed on Jun. 25, 2024, which is expressly incorporated herein by reference in its entirety.

### FIELD

The present invention relates to a method for processing sensor data. Furthermore, the present invention relates to a method for environment object detection, a method for control, and a processing device.

### BACKGROUND INFORMATION

Driver assistance systems and autonomous driving systems in vehicles require accurate environment detection of the vehicle environment. Environmental sensors, for example radar sensors, are used for this purpose. These environmental sensors provide measurement data, from which sensor data, in particular in the form of spectra, are calculated by processing. In turn, a data model comprising data values, in particular points, for example a point cloud, is calculated from the sensor data. The points reflect a spatial distribution of respective reflections of environment objects in the vehicle environment. From these point clouds, a processing model calculates a position, pose, class, and optionally further properties of relevant environment objects.

### SUMMARY

According to the present invention, a method for sensor data processing is provided. According to an example embodiment of the present invention, the method includes providing the sensor data of an environment sensor detecting at least one environment object in a sensor environment, wherein the sensor data contain at least spatial information obtained through reflections of the environment object and velocity information obtained through Doppler shifting; calculating, from the sensor data, a data model comprising data values that are assigned to the reflections of the environment object that are received by the environmental sensor, the data values having a multi-dimensional data structure with at least one spatial dimension and with a velocity dimension of the same rank; processing the data model by a processing model trained on the data structure, wherein the data model with the data values having the data structure forms the input data; and outputting the processed data model.

This allows local patterns and structures of environment objects to be detected even in the velocity dimension. The micro-Doppler signatures present in the environment objects can be detected in connection with the spatial information and can be taken into account in the evaluation. The environment objects, especially environment objects in need of protection, can be detected and recognized more accurately and reliably.

The velocity information is thus embedded in its own dimension in the data structure of the data values and therefore influences the arrangement and structure of the data values in the data model.

Environment objects in need of protection, such as pedestrians, bicycles, and animals, do not move like a rigid box but have a body as well as legs and/or arms that are movable relative to and at a different velocity than the body. For example, a walking person has one foot on the ground (no velocity relative to ground) while the other leg swings forward and therefore moves at a higher velocity than the body. Similarly, the arms swing at different velocities. One arm swings forward with respect to the body while the other one swings backward.

High-resolution environmental sensors, such as radar sensors, can measure these different velocities and detect the resulting micro-Doppler features.

The environmental sensor may be arranged on a motorized mobile device. The motorized mobile device may be a vehicle, in particular a motorized vehicle, for example a motor vehicle, a two-wheeler, in particular a motorcycle. The motorized mobile device may be a robot, for example a robotic mower.

The environmental sensor may be a radar sensor, a lidar sensor, an ultrasonic sensor, or a camera. The radar sensor may be an FMCW radar sensor and/or a MIMO radar sensor. The environmental sensor may provide measurement data on the environment object. The measurement data may be in the time domain.

The environment object may be an object, a facility, a building, a plant, or a creature. The environment object may be a road user. The environment object may be movable. The environment object may be a road user in need of protection, for example a person.

According to an example embodiment of the present invention, the sensor data may be processed or unprocessed measurement data of the environmental sensor. The sensor data may be processed measurement data of the environmental sensor. The sensor data may be processed for noise suppression in the sensor data. The sensor data may be present as a frequency spectrum. The sensor data may be calculated from the measurement data by Fourier transform, in particular fast Fourier transform (FFT). The sensor data may be present as a sparse frequency spectrum calculated from the frequency spectrum by at least one processing step, for example by applying a detector with a constant error rate (CFAR detector). The sensor data may comprise at least a distance of the environment object to the environmental sensor and a relative velocity of the environment object relative to the environmental sensor as dimensions. The sensor data may be a range-Doppler spectrum.

In comparison to the sensor data, the data values may have additional information, for example an azimuth angle, an elevation angle, and/or a radar cross section. The data values may be created depending on an information content in the frequency spectrum of the sensor data. The data values may be composed of the points in the frequency spectrum where information exists in both the spatial dimension and the velocity dimension above a particular threshold value. The data values may be composed of the points in the frequency spectrum where a local maximum is present and, optionally, which are above a particular threshold value.

The spatial information may include a distance of the environment object to the environmental sensor, spatial coordinates of the environment object, and/or at least one dimension of the environment object.

The spatial dimension may be a Cartesian coordinate, a polar coordinate, a distance between the environment object and the environmental sensor, an azimuth angle, or an elevation angle.

According to an example embodiment of the present invention, the data structure may have the velocity dimension in addition to the at least one spatial dimension. For example, the data structure may have the form [x, y, v], with two spatial dimensions x and y and the velocity dimension v. The velocity dimension is of the same rank as the at least one spatial dimension, which means that the velocity dimension can span a further dimension of a space specified by the data structure.

According to an example embodiment of the present invention, the processing model may be trained on the data structure by having the processing model trained on training data having the data structure.

The processing model may comprise a trained neural network, in particular a neural network trained by deep learning. The neural network has a multi-layered structure of multiple layers of neurons connected by weights (and biases). For recognizing patterns and structures, the processing model may also be trained in the velocity dimension, in particular the micro-Doppler features of environment objects. This allows road users in need of protection to be detected, in particular recognized, and classified more accurately and reliably.

The processing model may be a convolutional neural network (CNN). The latter uses convolutional layers, in particular two-dimensional convolutional layers, with convolutions for filtering and extracting features from the input data, in particular in order to identify structures and patterns in the input data. The convolutional layers may be sparse convolutions and may execute the convolution only at the locations of the input data where information is actually present. The convolutional layers may be submanifold convolutions, which limit the processing to informative data and omit uninformative data while maintaining the original dimension of the input data. The convolutions may be two-dimensional, three-dimensional, or higher-dimensional.

According to an example embodiment of the present invention, the processing model may comprise at least one pooling layer. The pooling layer may form the last layer of the multi-layered processing model, in particular in order to obtain a single feature vector for each data value.

The processing model may be an autoencoder. The latter uses an encoder, which converts the input data into a latent space, and a decoder, which converts the converted data back into the original space.

The processing model may be a support vector machine (SVM). The latter uses a separating line or hyperplane in multiple dimensions between classes of input data.

According to an example embodiment of the present invention, the processing model may be a transformer model. The latter uses the self-attention mechanism to take relationships between values of the input data into account, and in particular uses an encoder, which converts the input data into a latent space, and/or a decoder, which converts the converted data back into the original space. The spatial dimension and/or the velocity dimension may be used to calculate the positional embeddings of the transformer model or as positional embeddings of the transformer model. The spatial dimension and/or the velocity dimension may be scaled, in particular normalized, for the positional embeddings of the transformer model. The velocity dimension may be multiplied by a specified conversion factor. The conversion factor may be predefined and/or trained.

The processing model may be trained by the gradient descent method. A backpropagation in the processing model to be trained may calculate the gradient of the cost function for each weight and bias of the neural network of the processing model.

The data values of the data model and/or the values of the sensor data may be digitized, in particular also quantized.

In a preferred example embodiment of the present invention, it is advantageous if the data model is a point cloud comprising the data values as points. The point cloud may be spanned in an at least two-dimensional, in particular three-dimensional, space.

A preferred embodiment of the present invention in which the points are positioned in a Euclidean space, wherein the velocity dimension spans a dimension of the Euclidean space, is advantageous. The Euclidean space may be two-dimensional, three-dimensional, or higher-dimensional. The spatial dimension may be a further dimension of the Euclidean space.

In an advantageous example embodiment of the present invention, it is provided that the processing model applies the point-based convolution technique of the kernel point convolutions to the point cloud. Kernel point convolutions (KPConv) are a point-based convolution technique for, in particular unstructured, point clouds that position the weights of the convolution filters in the Euclidean space on the basis of kernel points.

The output of the point-based convolution technique may form the output as a processed data model.

In a preferred example embodiment of the present invention, it is provided that, when performing the point-based convolution technique, a distance calculation of at least one distance between two points of the point cloud is carried out by applying a weighted Euclidean distance norm. The weights of the Euclidean distance norm may be predefined and/or trained, for example through a preceding hyperparameter search. The Euclidean distance norm may assign at least one weight to the spatial dimension and may also assign at least one weight to the velocity dimension. The weight of the spatial dimension may be one. The weight of the velocity dimension may be different from the weight of the spatial dimension, in particular different from one.

Alternatively, the distance calculation may be carried out by a Mahalanobis distance determination, in which a distance is calculated taking into account the covariance between the points.

In a particular embodiment of the present invention, it is advantageous for the data model to be a tensor comprising the data values as elements. Some of the elements of the tensor may be uninformative, in particular zero. The tensor may be sparse, which means that many of the elements may be uninformative, in particular zero. The tensor may be a matrix. The tensor may be two-dimensional, three-dimensional, or higher-dimensional. The dimensions of the tensor may comprise a further dimension, an azimuth angle, and/or an elevation angle in addition to the spatial dimension and the velocity dimension. An intensity assigned to the reflection by the environment object may be the value at a point in the multi-dimensional space spanned by the tensor.

In a particular example embodiment of the present invention, it is advantageous if the data values of the data model are scaled prior to input into the processing model. The spatial dimension and/or the velocity dimension may be scaled, in particular normalized. The velocity dimension may be multiplied by a specified conversion factor. The conversion factor may be predefined and/or trained.

According to the present invention, a method for environment object detection is also provided. The environment object detection may comprise object recognition, with which environment objects are identified. In the process, it is determined whether and where environment objects are located. The environment detection may comprise object classification, by which the class of the environment objects is ascertained. The environment object detection may comprise free space recognition, in which areas of the environment that are free of obstacles and thus available for movement are ascertained. The environment object detection may comprise a regression analysis of the object parameter.

The object parameter may be a class, a position, a pose, a contour, a velocity, an acceleration, and/or at least one dimension of the environment object.

The data model processed by the processing model may form a (further) input for the object detection model. The input may form second input data in addition to input data of the object detection model. The input may be appended point by point or element by element to input data of the object detection model.

For example, for a point of a point cloud as input data of the object detection model, the information obtained from the processed data model by applying the processing model may be added to the point of the input data.

According to the present invention, a method for control with is also provided. The operation of the device in the case of a vehicle as the device may comprise operating a driver assistance system, a partially automated driving system, or an autonomous driving system. The operating parameter may be a steering angle, an acceleration, a deceleration, a velocity, and/or a position of the device.

According to the present invention, a processing device is also provided. The processing device may be arranged on the mobile device.

The method for sensor data processing, the method for object classification, and/or the method for control is preferably a computer-implemented method. The method for sensor data processing, the method for object classification, and/or the method for control is executable in the mobile device.

A computer program comprising machine-readable instructions that are executable on at least one computer and that, when executed, cause at least one of the methods of the present invention described above to run is also provided.

A memory unit that is machine-readable and accessible by at least one computer and on which the mentioned computer program is stored is also provided. The memory unit may be arranged in the device.

Further advantages and advantageous embodiments of the present invention emerge from the description of the FIGURE and the FIGURE.

### BRIEF DESCRIPTION OF DRAWING

FIG. 1 shows a method for control with a method for environment object detection and with a method for sensor data processing, according to example embodiment of the present invention.

### DETAILED DESCRIPTION OF EXAMPLE EMBODIMENTS

The present invention is described in detail below with reference to the FIGURE.

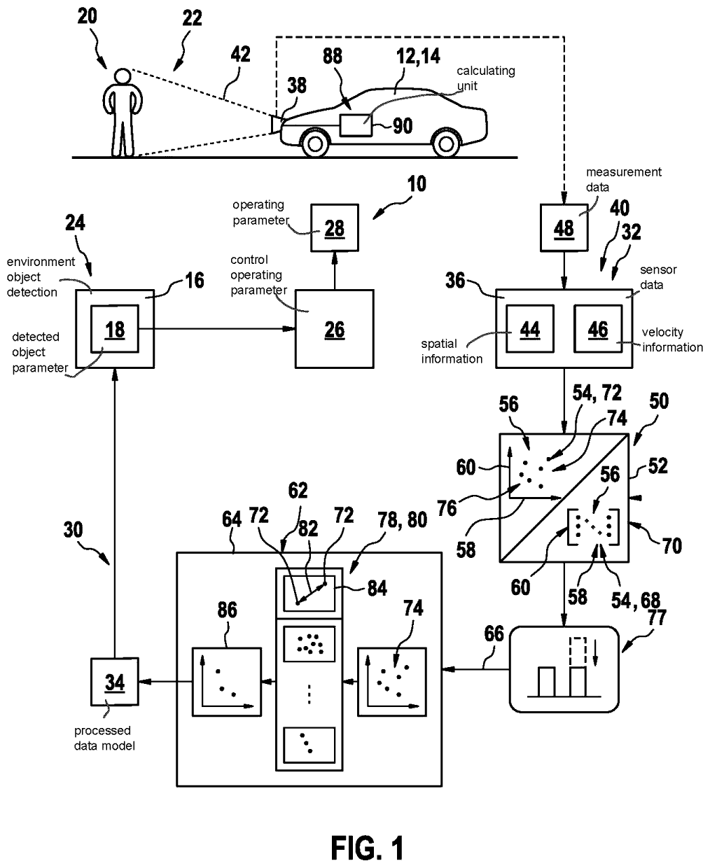

FIG. 1 shows a method for control with a method for environment object detection and with a method for sensor data processing, in each case in a particular embodiment of the present invention. The method for control 10 of an operating parameter of a motorized mobile device 12, for example a vehicle 14, comprises detecting 16 an object parameter 18 of at least one environment object 20 in an environment 22 of the vehicle 14 by a method for environment object detection 24 described in more detail below, and controlling 26 the operating parameter 28 depending on the detected object parameter 18. The operating parameter 28 may be a steering angle, an acceleration, a deceleration, a velocity, and/or a position. The object parameter 18 may be a class, a position, a pose, a contour, a velocity, an acceleration, and/or at least one dimension of the environment object 20.

The method for environment object detection 24 of the object parameter 18 comprises providing 30 a data model 34 processed by a method for sensor data processing 32 described in more detail below, and detecting 16 the object parameter 18 depending on the processed data model 34.

The method for sensor data processing 32 of sensor data 36 of at least one environmental sensor 38 arranged on the vehicle 14 comprises providing 40 the sensor data 36 of the environment sensor 38 detecting environment objects 20 in a sensor environment 42, in particular environment objects 20 in the environment 22 of the vehicle 14, wherein the sensor data 36 contains spatial information 44 obtained through reflections of the environment objects 20 and velocity information 46 obtained through Doppler shifting. The sensor data 36 are prepared from measurement data 48 of the environmental sensor 38. For example, the measurement data 48 are in the time domain and the sensor data 36 form a sparse frequency spectrum, which is, for example, calculated from a frequency spectrum by at least one processing step, for example by applying a detector with a constant error rate (CFAR detector).

Furthermore, a data model 52 is calculated 50 from the sensor data 36, the data model comprising data values 54 that are assigned to the reflections of the environment object 20 that are received by the environmental sensor 38, said data values having a multi-dimensional data structure 56 with at least one spatial dimension 58 and with a velocity dimension 60 of the same rank. Subsequently, the data model 52 is processed 62 by a processing model 64 trained on the data structure 56, wherein the data model 52 with the data values 54 having the data structure 56 forms the input data 66.

For example, the data model 52 is a tensor 70 comprising the data values 54 as elements 68, or a point cloud 74 comprising the data values 54 as points 72. The points 72 are positioned in a Euclidean space 76, wherein the velocity dimension 60 spans a dimension of the Euclidean space 76 and the spatial dimension 58 spans a further dimension of the Euclidean space 76.

The data values 54 of the data model 52 are preferably scaled in a scaling step 77 prior to input into the processing model 64, wherein the processing model 64, in particular, applies the point-based convolution technique 78 of the kernel point convolutions 80 to the point cloud 74. When performing the point-based convolution technique 78, a distance calculation of at least one distance 82 between two points 72 of the point cloud 74 is carried out by applying a weighted Euclidean distance norm 84. The weights of the Euclidean distance norm 84 may be predefined and/or trained, for example through a preceding hyperparameter search.

The output 86 of the point-based convolution technique 78 forms the processed data model 34, which is provided to the method for environment object detection 24.

The vehicle 14 comprises a processing device 88 with the environmental sensor 38, providing the sensor data 36, on the vehicle 14 and at least one calculating unit 90 for calculating and processing the data model according to the method for sensor data processing 32.

What is claimed is:

1. A method for sensor data processing of sensor data of at least one environmental sensor, the method comprising the following steps:
providing the sensor data of the environmental sensor detecting at least one environment object in a sensor environment, wherein the sensor data contain at least spatial information obtained through reflections of the environment object and velocity information obtained through Doppler shifting;
calculating, from the sensor data, a data model including data values that are assigned to the reflections of the environment object that are received by the environmental sensor, the data values having a multi-dimensional data structure with at least one spatial dimension and with a velocity dimension of a same rank;
processing the data model by a processing model trained on the data structure, wherein the data model with the data values having the data structure forms input data for the processing model; and
outputting the processed data model.

2. The method for sensor data processing according to claim 1, wherein the data model is a point cloud including the data values as points of the point cloud.

3. The method for sensor data processing according to claim 2, wherein the points are positioned in a Euclidean space, wherein the velocity dimension spans a dimension of the Euclidean space.

4. The method for sensor data processing according to claim 2, wherein the processing model applies a point-based convolution technique of kernel point convolutions to the point cloud.

5. The method for sensor data processing according to claim 4, wherein, when the point-based convolution technique is performed, a distance calculation of at least one distance between two points of the point cloud is carried out by applying a weighted Euclidean distance norm.

6. The method for sensor data processing according to claim 1, wherein the data model is a tensor including the data values as elements of the tensor.

7. The method for sensor data processing according to claim 1, wherein the processing model is a transformer model.

8. The method for sensor data processing according to claim 7, wherein the spatial dimension and/or the velocity dimension is used to calculate positional embeddings of the transformer model or used as positional embeddings of the transformer model.

9. The method for sensor data processing according to claim 1, wherein the data values of the data model are scaled prior to input into the processing model.

10. A method for environment object detection of at least one object parameter of at least one environment object in an environment of a motorized mobile device, the method comprising the following steps:
providing a data model processed by a method for sensor data processing, the method for sensor data processing including:
providing the sensor data of an environmental sensor detecting the environment object in a sensor environment, wherein the sensor data contain at least spatial information obtained through reflections of the environment object and velocity information obtained through Doppler shifting,
calculating, from the sensor data, a data model including data values that are assigned to the reflections of the environment object that are received by the environmental sensor, the data values having a multi-dimensional data structure with at least one spatial dimension and with a velocity dimension of a same rank,
processing the data model by a processing model trained on the data structure, wherein the data model with the data values having the data structure forms input data for the processing model; and
outputting the processed data model; and
detecting the object parameter depending on the processed data model.

11. A method for control of at least one operating parameter of a motorized mobile device, comprising the following steps:
detecting an object parameter of at least one environment object in an environment of the motorized mobile device, by:
providing a data model processed by a method for sensor data processing, the method for sensor data processing including:
providing the sensor data of an environmental sensor detecting at least one environment object in a sensor environment, wherein the sensor data contain at least spatial information obtained through reflections of the environment object and velocity information obtained through Doppler shifting,
calculating, from the sensor data, a data model including data values that are assigned to the reflections of the environment object that are received by the environmental sensor, the data values having a multi-dimensional data structure with at least one spatial dimension and with a velocity dimension of a same rank,
processing the data model by a processing model trained on the data structure, wherein the data model with the data values having the data structure forms input data for the processing model, and
outputting the processed data model; and
detecting the object parameter depending on the processed data model; and
controlling the operating parameter depending on the detected object parameter.

12. A processing device for a motorized mobile device, comprising:
an environmental sensor on the motorized mobile device, the environmental sensor configured to provide sensor data for detecting at least one environment object in an environment of the motorized mobile device; and
at least one calculating unit configured to process the sensor data, the calculating unit configured to:
provide the sensor data of the environmental sensor detecting the environment object in a sensor environment, wherein the sensor data contain at least spatial information obtained through reflections of the environment object and velocity information obtained through Doppler shifting,
calculate, from the sensor data, a data model including data values that are assigned to the reflections of the environment object that are received by the environmental sensor, the data values having a multi-dimensional data structure with at least one spatial dimension and with a velocity dimension of a same rank,
process the data model by a processing model trained on the data structure, wherein the data model with the data values having the data structure forms input data for the processing model, and
output the processed data model.
